(19) United States
(12) Patent Application Publication
(10) Pub. No.: US 2012/0169516 A1
(43) Pub. Date: Jul. 5, 2012

(54) METHOD AND SYSTEM FOR TRIGGERING COMMERCIAL VEHICLE INSPECTION

(76) Inventors: Richard Turnock, Toronto (CA); Japjeev Kohli, Waterloo (CA)

(21) Appl. No.: 12/981,192

(22) Filed: Dec. 29, 2010

(51) Int. Cl. G08G 1/00

(52) U.S. Cl. 340/928

(57) ABSTRACT

A system and method for triggering a vehicle inspection in a vehicle inspection bypass system. A handheld device transmits a signal containing the driver information in response to detecting an activation of an actuator on the handheld device. A vehicle mounted transponder detects the signal when the handheld device is in close proximity, and the driver information is stored in the transponder memory. Upon detecting an interrogation signal from a roadside reader, the transponder transmits a signal containing the driver information to the roadside reader. Based on the received driver information, a roadside controller determines whether a vehicle may bypass a vehicle inspection station.

### TECHNICAL FIELD

The present disclosure relates to commercial vehicle inspection bypass systems, and in particular to a system and method for triggering commercial vehicle inspections at commercial vehicle inspection bypass systems.

### BACKGROUND

Currently there are commercial vehicle inspection bypass systems that make use of transponders to identify a vehicle approaching an inspection station. Based on information known about the vehicle, the owner and a random factor, a signal is transmitted to the vehicle indicating that the vehicle has permission to bypass the inspection. This system relies almost entirely on vehicle information and the process does not directly use information about the driver, which may be different than the owner of the vehicle.

A new system is currently being established that will maintain centralized records of commercial vehicle drivers, and will standardize the Commercial Driver's License (CDL) carried by drivers. A commercial vehicle bypass system that utilizes driver information in determining which commercial vehicles should be inspected would be an efficient use of inspection resources and would enhance road safety. Therefore, it would be advantageous to provide a system and method that utilizes both driver and vehicle information to determine which commercial vehicles should be inspected.

### BRIEF SUMMARY

The present application describes systems and methods for triggering commercial vehicle inspection in commercial vehicle inspection bypass systems. The present application provides a commercial vehicle inspection bypass system that utilizes both driver-related information and vehicle-related information to determine which vehicles approaching an inspection station should be stopped for an inspection. The commercial vehicle inspection bypass system obtains driver and vehicle information from a transponder located within the vehicle.

In one aspect, the present application provides a method for triggering a vehicle inspection in a vehicle inspection bypass system, the system including a handheld device and a transponder, the handheld device and the transponder being located in a moving vehicle travelling in a roadway, the transponder having a transponder memory, the system further including at least one antenna, a reader connected to the antenna configured to process signals sent and received by the antenna, the method comprising: transmitting a short range RF signal from the handheld device, the signal containing driver information; storing, in the transponder memory, the driver information in response to detecting the short range RF signal; and transmitting a signal, containing the driver information, from the transponder to the reader in response to detecting an interrogating signal from the reader over the at least one antenna.

In another aspect, the present application describes a vehicle inspection bypass system for determining vehicle inspections in connection with vehicles traveling in a roadway, the system comprising: a transponder having a transponder memory; and a handheld device configured to transmit a short range RF signal containing driver information; wherein the transponder and the handheld device are located in a moving vehicle traveling in the roadway; and wherein the transponder is configured to: store in the transponder memory the driver information in response to detecting the short range RF signal from the handheld device; and to transmit a signal containing the driver information to a roadside reader in response to detecting an interrogation signal from the roadside reader over at least one antenna.

Other aspects and features of the present application will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present application, and in which:

FIG. 1 shows, in block diagram form, one example embodiment of a commercial vehicle inspection bypass system in accordance with the present disclosure;

FIG. 1A shows, in block diagram form, another example embodiment of a commercial vehicle inspection bypass system in accordance with the present disclosure;

FIG. 2 shows, in block diagram form, one example embodiment of a transponder for use with the commercial vehicle inspection bypass system of FIG. 1,

FIG. 3 shows, in block diagram form, one example embodiment of a handheld device for use with the commercial vehicle inspection bypass system of FIG. 1; and

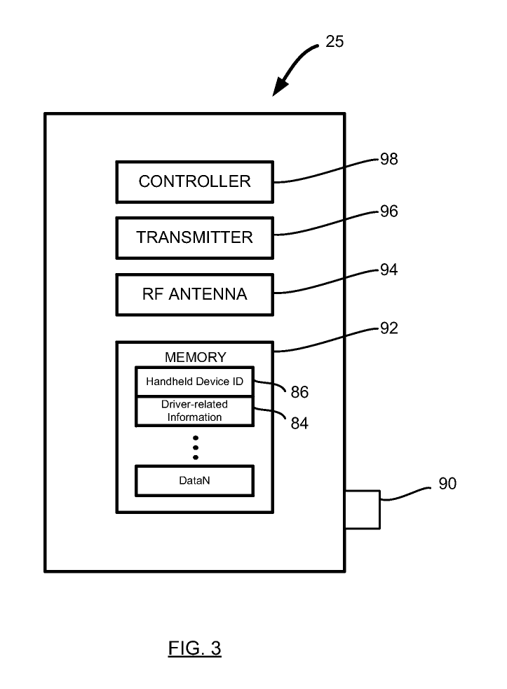

FIG. 4 shows a flowchart illustrating an example method of triggering vehicle inspections in a commercial vehicle inspection bypass system, according to one embodiment of the present application.

### DETAILED DESCRIPTION OF EXAMPLE EMBODIMENTS

The present disclosure relates to a means of associating a driver's identity with a commercial vehicle at commercial vehicle automatic vehicle identification (AVI) read points. The concept involves the use of a handheld device, such as an electronic key fob, to temporarily associate the driver identity with a vehicle mounted transponder. The AVI read point determines whether a commercial vehicle may bypass an inspection station based in part on the driver identity information received from the vehicle mounted transponder.

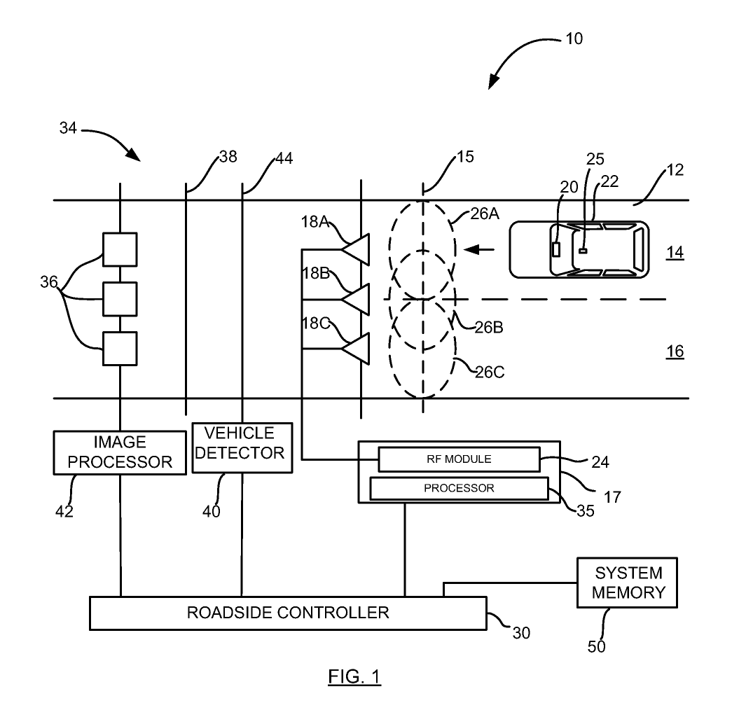

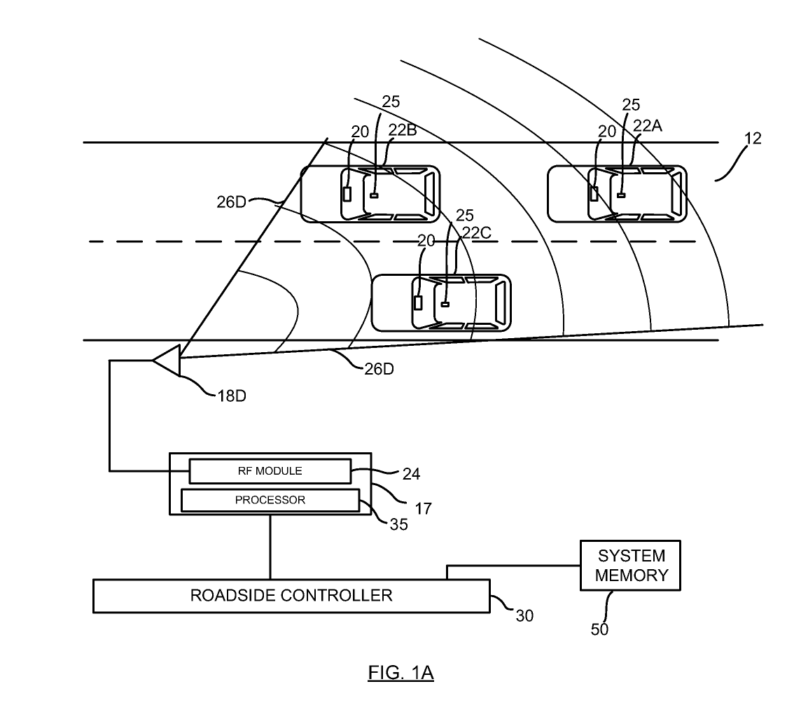

Reference is made to FIG. 1, which shows an example embodiment of a commercial vehicle inspection bypass system, illustrated generally by reference numeral 10. As shown in FIG. 1, the commercial vehicle inspection bypass system 10 in this example embodiment is installed in connection with a roadway 12 having a first and second adjacent lanes 14 and 16. In one example embodiment, the roadway 12 may be a two lane access roadway leading towards or away from the bypass station. The commercial vehicle inspection bypass system 10 in this example includes three roadway antennas 18A, 18B and 18C, each of which is connected to an Automatic Vehicle Identification (“AVI”) reader 17. It will be appreciated that other antenna configurations may be used and the number of antennas or the number of lanes may be different than those illustrated in FIG. 1. For example, the exemplary embodiment of FIG. 1 could be modified to eliminate the midpoint antenna 18B so that only two roadway antennas 18A, 18C would be used to provide coverage to the two lanes 14 and 16. The antennas 18A, 18B, 18C may, in some embodiments, be mounted to an overhead gantry or other structure. As well, in another embodiment, one lane 14 with one antenna 18A may be dedicated for commercial vehicle inspections.

In a further embodiment, the AVI reader 17 may cover a large roadway area containing multiple vehicles. For example, the commercial vehicle inspection bypass system 10 may utilize 5.9 GHz dedicated short-range communications (DSRC). As shown in FIG. 1A, antenna 18D provides a large coverage area 26D of the roadway such that it captures multiple vehicles 22A, 22B, 22C. The antenna 18D is connected the AVI reader 17.

With reference again to FIG. 1, the AVI reader 17 is a control device that processes signals that are sent and received by the roadway antennas 18A, 18B, and 18C, and includes a processor 35 and a Radio Frequency (“RF”) module 24.

The RF module 24 is configured to modulate signals from the processor 35 for transmission as RF signals over the roadway antennas 18A, 18B and 18C, and to de-modulate RF signals received by the roadway antennas 18A, 18B and 18C into a form suitable for use by the processor 35. In this regard, the AVI reader 17 employs hardware and signal processing techniques that are well known in the art. In another embodiment, the RF module 24 does not modulate signals but rather sends a continuous wave signal over the roadway antennas 18A, 18B and 18C. The processor 35 includes a programmable processing unit, volatile and non-volatile memory storing instructions and data necessary for the operation of the processor 35, and communications interfaces to permit the processor 35 to communicate with the RF module 24 and a roadside controller 30.

The roadway antennas 18A, 18B and 18C and the AVI reader 17 function to trigger or activate a transponder 20 (shown in the windshield of vehicle 22) in order to access and transfer information. It will be appreciated by those skilled in the art that the transponder 20 may also be mounted in other locations in the vehicle 22 accessible to the driver. The roadway antennas 18A, 18B and 18C are directional transmit and receive antennas which, in the illustrated embodiment, have an orientation such that each of the roadway antennas 18A, 18B and 18C can only receive signals transmitted from a transponder 20 when the transponder 20 is located within a coverage area associated with the antenna.

In this example embodiment, the roadway antennas 18A, 18B and 18C are located above the roadway 12 and arranged such that they have coverage areas 26A, 26B and 26C which are aligned along an axis 28 that is orthogonal to the travel path along roadway 12. In the embodiment illustrated, the major axis of the elliptical coverage areas 26A, 26B and 26C are co-linear with each other, and extend orthogonally to the direction of travel. As is apparent from FIG. 1, the coverage area 26A provides complete coverage of the first lane 14, and the coverage area 26C provides complete coverage of the second lane 16. The coverage area 26B overlaps both of the coverage areas 26A and 26C. The coverage area 26A, 26B, 26C of each antenna 18A, 18B, 18C includes at least a portion of the roadway.

It will be understood that although the coverage areas 26A, 26B and 26C are illustrated as having identical, perfect elliptical shapes, in reality the actual shapes of the coverage areas 26A, 26B and 26C will typically not be perfectly elliptical, but will have a shape that is dependent upon a number of factors, including RF reflections or interference caused by nearby structures, the antenna pattern and mounting orientation.

It will also be understood that, although elliptical coverage areas are disclosed in the above embodiment, other shapes could also be used for the coverage areas 26A, 26B or 26C. Furthermore, while three coverage areas 26A, 26B, 26C are shown, the number of coverage areas may vary.

The AVI reader 17 is connected to the roadside controller 30. The roadside controller 30 may be configured to determine vehicle inspection bypass decisions based on information it receives from the AVI reader 17.

The commercial vehicle inspection bypass station 10 may include a vehicle imaging system, which is indicated generally by reference numeral 34. The imaging system 34 includes an image processor 42 to which is connected a number of cameras 36, arranged to cover the width of the roadway for capturing images of vehicles as they cross a camera line 38 that extends orthogonally across the roadway 12. The image processor 42 is connected to the roadside controller 30, and operation of the cameras 36 is synchronized by the roadside controller 30 in conjunction with a vehicle detector 40. The vehicle detector 40 which is connected to the roadside controller 30 detects when a vehicle has crossed a vehicle detection line 44 that extends orthogonally across the roadway 12, which is located before the camera line 38 (relative to the direction of travel). The output of the vehicle detector 40 is used by the roadside controller 30 to control the operation of the cameras 36. The vehicle detector 40 can take a number of different configurations that are well known in the art, for example it can be a device which detects the obstruction of light by an object.

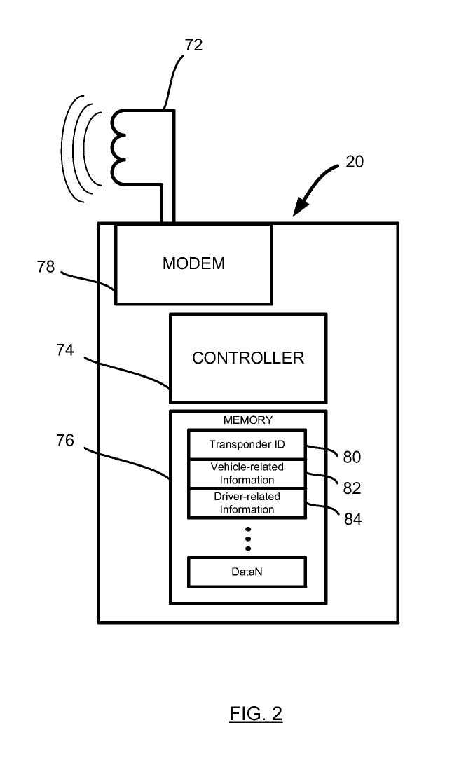

As shown in FIG. 1, the commercial vehicle inspection bypass system 10 utilizes a transponder 20 that is located in a vehicle 22 traveling on the roadway 12. Referring now to FIG. 2, the transponder 20 has a modem 78 that is configured to de-modulate RF signals received by a transponder antenna 72 into a form suitable for use by a transponder controller 74. The modem 78 is also configured to modulate signals from the transponder controller 74 for transmission as an RF signal over the transponder antenna 72.

The transponder 20 also includes a transponder memory 76 that is connected to the transponder controller 74. The transponder controller 74 may access the transponder memory 76 to store and retrieve data. The transponder memory 76 may be random access memory (RAM) or flash memory. In one embodiment, the transponder memory 76 is the integrated memory of a microcontroller.

The transponder memory 76 can be used to store vehicle-related information 82 for the vehicle 22 associated with the transponder 20. In an embodiment, the vehicle-related information 82 may include data representing the class, weight and/or number of axles of the vehicle 22, as well as ownership and licensing information for the vehicle 22. It will be appreciated by those skilled in the art that these embodiments and examples are not exhaustive and that the vehicle-related information 82 may comprise other data not specifically identified in the examples above.

The transponder memory 76 may also store other information which may be necessary for communication with the vehicle inspection bypass system 10. For example, the transponder memory 76 may store a unique transponder identification number 80. The unique transponder identification number 80 may be transmitted by the transponder 20 as a part of any of its transmissions and used by the AVI reader 17 for determining the identity of the source of the transmission. The AVI reader 17 may also include the unique transponder identification number 80 in any transmission originating from the antennas 18A, 18B, and 18C and destined for the transponder 20 that corresponds to the unique identification number 80. In this way, the system 10 ensures that communications which are transmitted by the antennas 18A, 18B, or 18C that are intended to be received by a specific transponder 20 are disregarded by other transponders which share the coverage areas 26A, 26B, and 26C with the transponder 20.

The transponder memory 76 may have a location of memory reserved for storing data which may be altered by a handheld device 25. As shown in FIG. 2, this location of memory may include, for example, fields for recording driver-related information 84. The driver-related information 84 may, for example, be a unique handheld device ID number 86, the driver's license number or both.

The handheld device 25 includes memory 92, a RF antenna 94, a transmitter 96 and a controller 98. The memory 92 may store in a reserved section of memory a unique handheld device ID number 86 associated with the handheld device 25. This would allow the transponder 20 to identify the particular handheld device 25 that transmitted the driver-related information 84 to it. The unique handheld device ID number 86 may be factory coded onto the handheld device 25, or may be programmed onto the handheld device 25 using another method. As well, the memory 92 may store driver-related information 84 such as a driver's license number. The handheld device 25 may be programmed with the driver-related information 84 (and in some embodiments also with the unique handheld device ID number 86) at a ‘programming station’ operated by, for example, trucking companies or the Department of Transportation (DoT). In some embodiments, the driver-related information 84 may be the unique handheld device ID number 86. A system memory 50 or a third party database may maintain records with the unique handheld device ID numbers 86 and the corresponding driver's license number of the driver possessing the handheld device 25.

The handheld device 25 is designed to transmit a low-power short-range RF signal over the RF antenna 94; at the same frequency normally used by the transponder 20. The signal is not continuously or periodically transmitted from the handheld device 25. The handheld device 25 may include an actuator 90, for example a push button, for triggering the handheld device 25 to transmit the signal containing the information stored in memory 92 over the RF antenna 94. The handheld device 25 may be, for example, an electronic key fob.

The transponder 20 is configured to detect the handheld device 25 signal transmission containing driver-related information 84 using the transponder antenna 72. The transponder 20 does not require hardware modifications in order to detect and accept communications from the handheld device 25. The transponder 20 is further configured to store the driver-related information 84 in its memory 76.

The transponder 20 may be configured to cause the transponder antenna 72 to transmit at least some of the data stored in the transponder memory 76 upon the receipt of an appropriate signal from one of the roadway antennas 18A, 18B, and 18C. For example, in one embodiment the AVI reader 17 is configured to cause the roadway antennas 18A, 18B, and 18C to periodically transmit an interrogation signal. Upon receipt of the interrogation signal, the transponder controller 74 may read the contents of the transponder memory 76 and transmit at least some of the contents of the transponder memory 76 using the transponder antenna 72. In some cases, the transponder controller 74 will be configured to cause the transponder antenna 72 to transmit all of the contents of the transponder memory 76 in response to the receipt of an interrogation signal from one of the roadway antennas 18A, 18B or 18C.

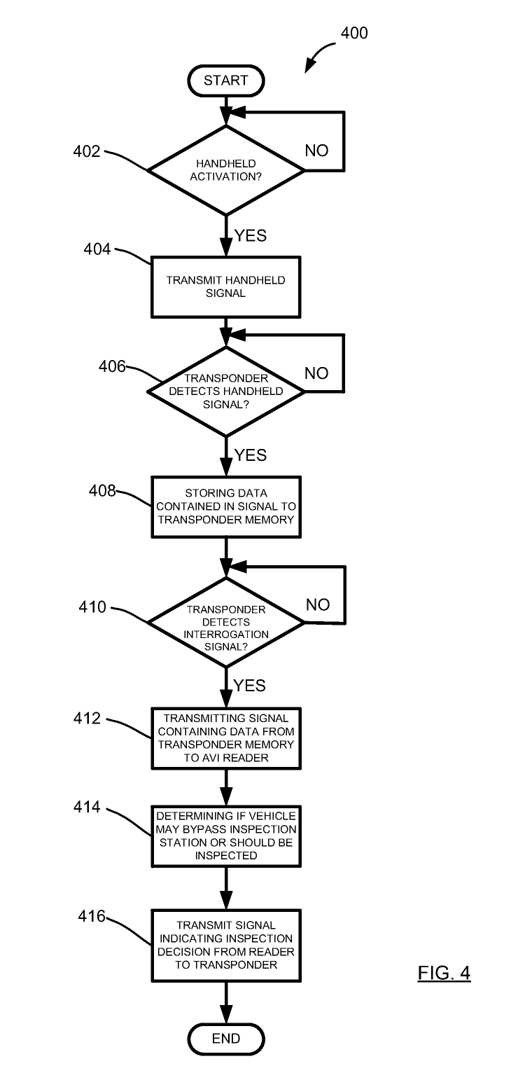

Operation of the commercial vehicle inspection bypass system 10 is illustrated with reference to FIG. 4, which shows an example method 400 of triggering a commercial vehicle inspection. The method 400 begins in step 402 where the handheld device 25 waits to receive an activation signal. As previously discussed, the handheld device 25 does not continuously or periodically transmit the signal containing driver-related information 84. In order for the handheld device 25 to transmit this signal to the transponder 20 located within the vehicle, the handheld device 25 must be activated. The activation of the handheld device 25 may be effected by receiving an indication from the actuator 90, such as a depressed button on the handheld device 25. In response to receiving an activation signal (block 402), for example in the form of a depressed button, the handheld device 25 will transmit the signal containing driver-related information 84 (block 404). As previously discussed, the signal may be a low-power short-range RF signal at the same frequency normally used by the transponder 20. The handheld device 25 therefore may operate, for example, under FCC Part 15 due to the low output and short transmissions. The transmitted signal contains driver-related information 84, for example, a unique handheld device ID number of the handheld device 25, the driver's license number or both.

The transponder 20 detects the signal from the handheld device 25 (block 406) and stores the received driver-related information 84 into the transponder memory 76 (block 408). In order for the transponder 20 to detect the signal from the handheld device 25, the handheld device 25 is placed in very close proximity to the transponder 20. Close proximity between the handheld device 25 and the transponder 20 is required due to the short range of the RF signal transmitted by the handheld device 25. Very close proximity may be defined, for example, as the distance corresponding to the frequency of the short range RF signal under FCC Part 15. The distance may be, for example, less than 3 meters between the handheld device 25 and the transponder 20. The handheld device 25 is not attached to any component in the vehicle or any other object. This allows a driver to use their handheld device 25 in other vehicles with other transponders 20. In order to effect the close proximity between the handheld device 25 and the transponder 20, the driver holds the handheld device 25 close to the transponder 20 located within the car. When the handheld device 25 is within very close proximity to the transponder 20, the transponder 20 detects the signal and stores the driver-related information 84 received in the signal to its memory 76. In an embodiment, the transponder 20 stores in memory 76 both the unique handheld device ID number 86 and the corresponding driver-related information 84, such as the driver's license number. In response to detecting the signal and storing the driver-related information 84, the transponder 20 may be configured to activate audio and/or visual indicators. The indicators may indicate to the driver the successful association between the handheld device 25 and the transponder 20; that is the transponder 20 has stored the information received from the handheld device 25. In some embodiments, there may be indicators on the handheld device 25 to indicate the successful programming of the transponder 20. This would avoid having to modify the existing transponders 20 to provide the output indication regarding the successful association between the handheld device 25 and the transponder 20.

In an embodiment, the transponder 20 is configured with software to ensure that the driver-related information 84 sent from handheld device 25 to the transponder 20 is write-protected. This would ensure that the driver-related information 84 received from the handheld device 25 is not over-written through new software or software upgrades in the transponder 20. The information received from the handheld device 25 may be stored in a reserved section of memory in the existing data layout of the transponder 20. In one embodiment, the driver-related information 84 is protected by ignoring programming messages, from for example the AVI reader 17, attempting to change the driver-related information 84 relayed from the handheld device 25. Alternatively, programming messages changing information may be accepted, so as to not interfere with the operating of the existing commercial vehicle inspection bypass system 10, but the driver-related information 84 within the transponder 20 would change back after a predetermined interval.

However, there may be instances where multiple drivers utilize the same commercial vehicle containing the same transponder 20 at different times. In an embodiment, the driver-related information 84 stored in the transponder memory 76 may be overwritten by a different handheld device 25 than the one used to previously transfer driver-related information 84 to the transponder 20.

When the transponder 20 has driver-related information 84 stored in memory 76, and it receives a signal from another handheld device 25 containing new driver-related information 84, the transponder 20 replaces the existing driver-related information 84 with the new driver-related information 84 received. In this way, any driver driving the commercial vehicle will be able to update the transponder memory 76 with their driver-related information 84.

In some embodiments, when the transponder 20 stores the driver-related information 84 in the transponder memory 76, the transponder 20 also stores a timestamp of when that information was received. By providing a timestamp with the driver-related information 84, the transponder 20 may maintain in the transponder memory 76 a small number of recently received driver-related information 84 that has been stored on the transponder 20. This may allow the transponder 20 to be queried by the AVI reader 17 (using a different interrogation signal) or by another device regarding what drivers have been driving the commercial vehicle recently and when they drove the vehicle. In this embodiment, the transponder 20, although containing a history of driver-related information 84 in the transponder memory 76, will only transmit information regarding the most recent driver-related information 84 stored on the transponder 20 in response to receiving the interrogation signal from the AVI reader 17.

As previously discussed, in addition to the driver-related information 84 stored on the transponder 20, the transponder 20 may also store vehicle-related information 82. The vehicle-related information 82 may include characteristics of the vehicle, such as vehicle class, weight of the vehicle, ownership, company and licensing information, and date the vehicle was last inspected.

After the transponder 20 has received and stored the driver-related information 84, it waits for an interrogation signal from the AVI reader 17 (block 410). In response to receiving an interrogation signal from the AVI reader 17, the transponder 20 transmits a signal using its RF antenna 72 containing both the driver-related information 84 and the vehicle-related information 82, to the AVI reader 17 (block 412).

The roadside controller 30 of the commercial vehicle inspection bypass system 10 determines whether a vehicle should stop for an inspection based in part on the received driver-related information 84 (block 414). In an embodiment, the roadside controller 30 receives driver-related information 84 in the form of the unique handheld device ID number 86. The roadside controller 30 may access system memory 50, or may access a third party database, that contains records of the unique handheld device ID numbers 86 and the corresponding driver license number of the driver possessing the handheld device 25. For example, the handheld device 25 and associated driver's license may be read or recorded by the trucking company or DoT when the driver receives the handheld device 25. The association between the unique handheld device ID number 86 and the driver's license number may be stored in the system memory 50 or the third party database. This implementation, having only the unique handheld device ID number 86 stored on the handheld device 25 would minimize the amount of data encoded on the handheld device 25, as well as ensuring that the driver's personal and confidential information is protected in secure database systems.

Once the roadside controller 30 has determined the driver's license number, either directly from the received driver-related information 84 from the transponder 20 or by looking it up using the unique handheld device ID number 86, the roadside controller 30 may access the driving record of the driver. The roadside controller 30 may connect with a third party database, such as DOT records, to access the driving record corresponding to the received driver license number. The driving record may contain information such as driver's name, licence number, class, expiry date, conditions/restrictions, height, date of birth, gender and status information, driving-related convictions, suspensions, earliest licensed date available, points total and medical due date (requirement in some areas for commercial drivers). The points system allocates points against a driver for driving-related offence convictions. In some embodiments, the roadside controller 30 may also evaluate the received vehicle-related information 82 in the determination of whether a vehicle should be inspected at the bypass station (block 414).

Based on the received driver-related information 84, and in some embodiments also the vehicle-related information 82, the roadside controller 30 may determine that the vehicle should be inspected. For example, if a driver has reached the designated limit under the points system, the roadside controller 30 may determine that the vehicle is selected for an inspection. As well, if the vehicle-related information 82 indicates that the vehicle has not been inspected for long period of time, the roadside controller 30 will determine that the vehicle should be inspected. The roadside controller 30 may also utilize a random factor in the determination of whether a vehicle may bypass the inspection station, such that a driver and vehicle without any potential problems may still be selected for an inspection.

Once the roadside controller 30 in the commercial vehicle inspection bypass system 10 determines whether or not a vehicle will be stopped for an inspection, the roadside controller 30 prompts the AVI reader 17 to transmit a signal over the roadway antennas 18A, 18B, 18C to the transponder 20 (416). The type of signal transmitted from the AVI reader 17 to the transponder 20 is dependent on the inspection determination made by the roadside controller 30. An authorization signal may be transmitted to the transponder 20 when the roadside controller 30 determines that the vehicle may bypass the inspection station. Alternatively, an inspection signal is transmitted to the transponder 20 when the roadside controller 30 determines that the vehicle is selected for an inspection.

In response to detecting either an authorization signal or an inspection signal from the AVI reader 17, the transponder 20 may indicate to the driver whether they may bypass the inspection station using audio and/or visual indication means on the transponder 20. For example, a green light may flash when the transponder 20 receives an authorization signal from the AVI reader 17. In response to receiving an inspection signal, the transponder 20 may flash a red light flash and/or activate an audio sound that will continue to sound until the driver enters the inspection station area.

Alternatively, in a further embodiment, once the roadside controller 30 in the commercial vehicle inspection bypass system 10 determines whether or not a vehicle will be stopped for an inspection, the roadside controller 30 may indicate to the driver the decision via an indication means located at the roadside. The indication means may be, for example, a red and green light system. The light system may be triggered by the roadside controller 30 to indicate to drivers that the vehicle will be stopped for an inspection using a red light, or to indicate that the vehicle may bypass the inspection station using a green light.

In another embodiment, the handheld device 25 is a means to verify that the transponder 20 is functioning properly. For example, an actuator on the handheld device 25, such as a depressed button, may send a test signal to the transponder 20 to test the basic functions of the transponder 20. In response to receiving the test signal, the transponder 20 may perform a battery voltage check, audio and visual indicator check, and/or a RF receiver check. The transponder 20 may indicate the results of these checks to the driver using visual and/or audio indication means located on the transponder 20. Alternatively, the results of these checks may be indicated visually and/or audibly on the handheld device 25 based on a received reply signal from the transponder 20.

In another embodiment, the handheld device 25 may be an electronic card. In this embodiment, the transponder 20 would include a card reader. Typical available card readers operate at low power, such as 5 volts and use 3 mA of current. In an embodiment, the transponder 20 would be alerted to power up the card reader using a signal or another indication means, such as for example, a depressed button on the transponder 20. After receiving an indication to power up, the transponder 20 would continue to be powered for a predetermined duration or until the electronic card is successfully read. This arrangement would prevent a high impact on the battery life of the transponder 20. The electronic card would contain driver-related information 84 that is transferred to the transponder 20 when the electronic card is swiped in the card reader.

Certain adaptations and modifications of the invention will be obvious to those skilled in the art when considered in light of this description. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

1. A method for triggering a vehicle inspection in a vehicle inspection bypass system, the system including a handheld device and a transponder, the handheld device and the transponder being located in a moving vehicle travelling in a roadway, the transponder having a transponder memory, the system further including at least one antenna, a reader connected to the antenna configured to process signals sent and received by the antenna, the method comprising:
transmitting a short range RF signal from the handheld device, the signal containing driver information;
storing, in the transponder memory, the driver information in response to detecting the short range RF signal; and
transmitting a signal, containing the driver information, from the transponder to the reader in response to detecting an interrogating signal from the reader over the at least one antenna.

2. The method of claim 1 wherein the transponder detects the signal from the handheld device when the handheld device is in close proximity to the transponder.

3. The method of claim 2, wherein close proximity is characterized as the distance corresponding to the frequency of the short range RF signal under FCC Part 15.

4. The method of claim 1, further comprising:
determining, by a controller connected to the reader, whether a vehicle may bypass a vehicle inspection station based in part on the received driver information; and
transmitting a signal from the reader over the at least one antenna to the transponder indicating the vehicle inspection determination.

5. The method of claim 1, wherein the handheld device transmits the signal in response to detecting an activation of an actuator on the handheld device.

6. The method of claim 1, wherein the handheld device is an electronic key fob.

7. The method of claim 1, wherein the signal from the transponder further contains vehicle information.

8. The method of claim 1 wherein the driver information includes a unique identification number of the handheld device.

9. The method of claim 1, wherein the driver information includes a driver's license number.

10. The method of claim 1, wherein the controller uses the driver information to access the driver's driving record.

11. The method of claim 1, wherein the controller makes the determination based also in part on vehicle information received in the signal transmitted from the transponder.

12. A vehicle inspection bypass system for determining vehicle inspections in connection with vehicles traveling in a roadway, the system comprising:
a transponder having a transponder memory; and
a handheld device configured to transmit a short range RF signal containing driver information;
wherein the transponder and the handheld device are located in a moving vehicle traveling in the roadway; and
wherein the transponder is configured to: store in the transponder memory the driver information in response to detecting the short range RF signal from the handheld device;
and to transmit a signal containing the driver information to a roadside reader in response to detecting an interrogation signal from the roadside reader over at least one antenna.

13. The system of claim 12 wherein the transponder receives the signal from the handheld device when the handheld device is in close proximity to the transponder.

14. The system of claim 12, wherein the handheld device includes an actuator and the handheld device is configured to transmit the signal in response to detecting activation of the actuator.

15. The system of claim 12, wherein the at least one antenna transmits and receives RF signals and is positioned to define a capture zone within the roadway.

16. The system of claim 12, wherein the roadside reader is coupled to the at least one antenna and configured to process signals sent and received by the at least one antenna.

17. The system of claim 12 further comprising a controller coupled to the reader, wherein the controller is configured to determine whether the vehicle may bypass a vehicle inspection station based in part on the received driver information.

18. The system of claim 17, wherein the controller determines whether the vehicles may bypass a vehicle inspection station based also in part on vehicle information received in the signal from the transponder.

19. The system of claim 12, wherein the roadside reader is configured to transmit a signal over the at least one antenna to the transponder indicating a vehicle inspection determination.

20. The system of claim 12, wherein the system further includes a system memory for storing handheld device identification numbers and their associated driver information.
